(19) United States
(12) Patent Application Publication
(10) Pub. No.: US 2019/0355015 A1
(43) Pub. Date: Nov. 21, 2019

(54) MOST INFLUENTIAL CUSTOMER SCORING

(71) Applicant: T-Mobile USA, Inc., Bellevue, WA (US)

(72) Inventors: Tatiana DASHEVSKIY, Edmonds, WA (US); Rami AL-KABRA, Bothell, WA (US); Jeffrey SEWELL, Kirkland, WA (US)

(21) Appl. No.: 15/982,322

(22) Filed: May 17, 2018

(51) Int. Cl. G06Q 30/02

(52) U.S. Cl. CPC G06Q 30/0254; G06Q 50/01; G06Q 30/0272; G06Q 30/0242

(57) ABSTRACT

This disclosure describes techniques for identifying most influential customers by determining various influence scores and metrics associated with each in-network customer and off-network customers that communicate with one or more in-network customers. A particular in-network customer can be assigned or have calculated for him or her a social media influence score, a voice call score, and an SMS score, and a particular off-network customer can be assigned or have calculated for him or her an acquisition score. The scores can be used in various context to generate recommendations for products and/or services, provide targeted marketing, and/or conduct performance analysis.

### BACKGROUND

Staying within current and relevant marketing trends and understanding targeted audiences is key to increasing overall engagement with customers. Influencing customers using traditional marketing techniques can be difficult as more and more customers are becoming sophisticated and knowledgeable about the various product and/or service offerings and are often dismissive of advertising. In this regard, identifying existing customers that can serve as potential influencers is proving to be a more profitable path for many businesses.

An influential customer is someone who promotes certain goods and/or services that are offered by a company through their own network of friends and contacts. Because influential customers provide increased peer influence on social networks and other communication platforms, the more a customer becomes a brand advocate, the more influence and social value they have, ultimately resulting in higher sales and profits for companies. In addition to marketing, metrics, statistics, and/or other data, influential customers can be used to conduct analysis, wherein information obtained from various analysis can be used to provide and/or manage product and/or service offerings, improve network performance, troubleshoot, provide recommendations, and/or so forth. In this regard, measuring customers' potential influence factor at least partially based on context can help provide targeted analytics to gain the most influential customers' insight.

### BRIEF DESCRIPTION OF THE DRAWINGS

The detailed description is described with reference to the accompanying figures, in which the left-most digit(s) of a reference number identifies the figure in which the reference number first appears. The use of the same reference numbers in different figures indicates similar or identical items.

FIG. 1 illustrates example architecture for determining influential scores for in-network and off-network customers based on the customers' social media activities, voice call activities, and/or SMS activities.

FIG. 2 is a block diagram showing various components of one or more illustrative computing nodes that identify most influential in-network customers.

FIG. 3 is a flow diagram of an example process for determining a social media influence score.

FIG. 4 is a flow diagram of an example process for determining a voice call influence score.

FIG. 5 is a flow diagram of an example process for determining a short message service (SMS) influence score.

FIG. 6 is a flow diagram of an example process for determining an acquisition score.

### DETAILED DESCRIPTION

This disclosure is directed to techniques for determining various influence scores that are associated with customers in a wireless telecommunication network to identify the most connected and active customers. In various embodiments, scores can comprise a social media influence score, a voice call influence score, an SMS influence score, and an acquisition score. In some embodiments, the influencer identification application can determine the influence scores by leveraging information associated with usage data which comprise call detail records (CDRs) and enhanced data records (EDRs) and PageRank algorithms. Example embodiments may provide many practical applications. For example, the influence scores can be used to generate recommendations in various contexts based on data derived from the one or more influence scores. One type of recommendation that can be generated by example embodiments is recommending specific customers for influencer marketing. In this regard, some systems and methods may utilize information associated with the influence scores in order to provide targeted, actionable information to customers.

In various embodiments, information associated with the influence scores can be used to collect metrics from targeted customers (i.e., the most influential customers) for analyzing network performance, wherein the metrics can include call failure rates, data speeds, and other performance markers. The metrics collected from targeted customers can be compared to the metrics of an aggregated set of other in-network customers of the telecommunication network in order to determine whether the network performance is optimal, consistent, reliable, and secure. Thus, another type of recommendation that can be generated by example embodiments is recommending performance improvement of the carrier network and mitigating any identified problems or potential problems.

In various embodiments, link analysis techniques such as PageRank techniques can be applied to characterize various metrics such as the influence scores associated with each customer using CDRs and EDRs, which can depict customers' HTTP and HTTPs traffic. Accordingly, information associated with the influence scores and influence score distribution can be used for targeting purposes and/or analytics. The techniques described herein may be implemented in a number of ways. Example implementations are provided below with reference to the following figures.

### Example Architecture

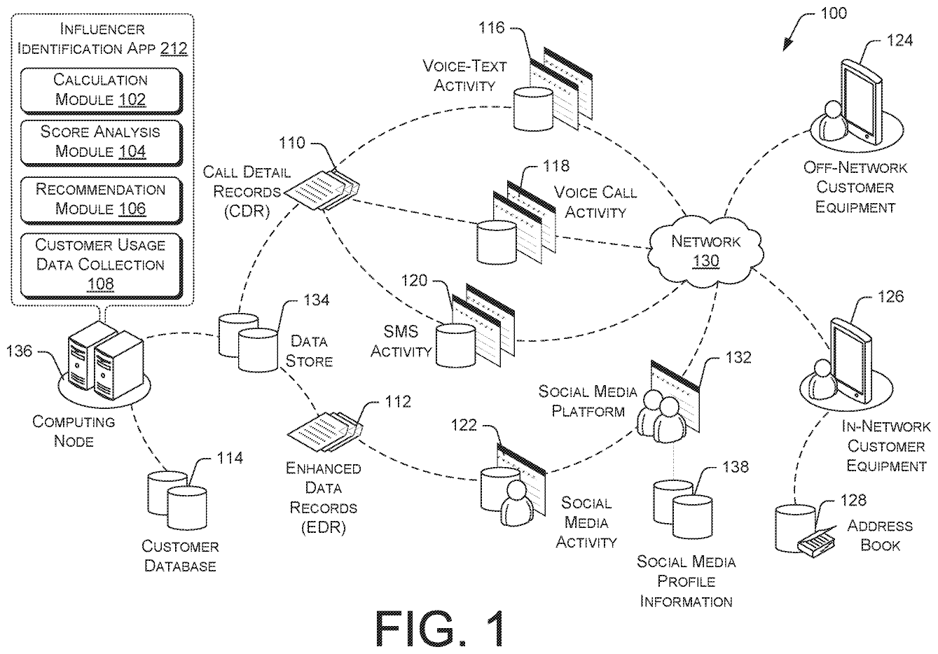

FIG. 1 illustrates example architecture for identifying most connected and active customers by determining influence scores that are associated with each in-network customer. The modules, systems, and/or engines shown in FIG. 1 represent a set of executable software instructions and the corresponding hardware (e.g., memory and processor) for executing the instructions. However, one skilled in the art will readily recognize that various additional functional modules and engines may be used with the influencer identification application to facilitate additional functionality that is not specifically described herein.

The architecture 100 includes a wireless telecommunication network 130 having an in-network customer equipment 126 that is operated by an in-network customer of a telecommunication network and an off-network customer equipment 124 that is operated by an off-network customer. The network 130 comprises any communications network utilizing any one of a number of well-known transfer protocols (e.g., HTTP). Examples of communication networks include a local area network (LAN), a wide area network (WAN), the Internet, mobile telephone networks, plain old telephone (POTS) networks, wireless data networks (e.g., Wi-Fi® and WiMax® networks), and/or so forth. In various embodiments, the customer equipment 124, 126 may include a personal computer, mobile handsets, smartphones, tablet computers, personal digital assistants (PDAs), smart watches, and/or other electronic devices executing conventional web browser applications, or applications that have been developed for a specific platform (e.g., operating system, computer system, or some combination thereof).

The architecture 100 may further include an influencer identification application 212. The influencer identification application 212 may reside in whole or in part on one or more computing nodes 136 (e.g., distributed across several server computers in various arrangements) in the network and executed thereon. The one or more computing nodes 136 may include general-purpose computers, such as desktop computers, tablet computers, laptop computers, servers, or other electronic devices that are capable of receiving inputs, processing the inputs, and generating output data. In still other embodiments, the one or more computing nodes 136 may be virtual computing devices in the form of computing nodes, such as virtual machines and software containers. In various embodiments, a wireless telecommunication carrier that provides the wireless telecommunication network, and/or a third-party entity that is working with the mobile telecommunication carrier may control the computing nodes 136.

The influencer identification application 212 comprises a calculation module 102, a score analysis module 104, a recommendation module 106, and a customer usage data collection 108. The influencer identification application 212 may be a standalone application or a part of another application. The influencer identification application 212 may access and analyze information retrieved from a data store 134 or other data sources such as in-network customer equipment 126 and off-network customer equipment 124 in order to calculate influence scores associated with one or more customers.

In this regard, the customer usage data collection 108 collects customer usage data as received by in-network customer equipment 126 and off-network customer equipment 124. The customer usage data collection 108 can store in the data store 134 a data record or multiple data records such as call detail records (CDRs) 110 or summaries of CDRs 110 that comprise voice traffic data and SMS data and enhanced data records (EDRs) 112 or summaries of EDRs 112, as well as Internet protocol detail records (IPDRs) or summaries of IPDRs associated with each customer (not pictured). CDRs 110 comprise details of a telephone call or other telecommunications transactions such as text message that passes through an in-network customer device 126. CDRs 110 can include minutes of use for voice calls, call duration or call length, call count, SMS count, SMS size, SMS percentage, percentage of outbound and inbound calls, number of calls in a given direction, calls to numbers, call volume, number of contacts, the total volume to each contact, call logs, and/or so forth. In various embodiments, call logs contain various other data including data regarding SMS, multi-media messaging service (MMS), instant messaging (IM), and Internet data between or among in-network customer equipment 126, off-network customer equipment 124, telephones, computing nodes, or any combination thereof. It is noted that, consistent with current privacy laws, CDRs 110 do not include recordings of conversations or messages, transcription of conversations or messages, textual content, pictorial content, video content, and/or so forth.

Furthermore, EDRs 112 can comprise information such as information related to duration, data volume, website(s) visited, quality of service per flow, quality of service per event, amount of data usage, data related to a customer's social media on various social network platforms 132, and/or so forth. It is noted that, consistent with current privacy laws, EDRs 112 do not include certain data related to user activity such as any activity that occurs on a website. The customer usage data collection 108 can be configured to collect usage data over a specific time period (e.g., monthly, quarterly, etc.), and also store historical usage data, such as over a customer's lifetime of being an in-network customer of the telecommunication network. In various embodiments, CDRs 110 can be categorized into voice-text activity 116, voice activity 118, and SMS activity 120 Similarly, EDRs 112 can be categorized into social media activity 122 and other types of data usage activity (not pictured).

In various embodiments, the data store 134 can comprise other data sources for storing and managing data related to network-related information, device- or equipment-related information, regulatory information for networks and devices or equipment, device manufacturer information, and/or so forth. The network information may include information regarding the technical and operational status of the wireless telecommunication network. For example, network information of the network may indicate that Long-Term Evolution (LTE) spectrum coverage (or other spectrum coverage) is unavailable in a particular geographical area or that a network node was temporarily overwhelmed with network traffic at a particular time due to a major event. The device or equipment information of customer equipment may indicate the technical capabilities, feature settings, and operational statuses of the customer equipment. For example, equipment information for the in-network customer equipment 126 may indicate that Wi-Fi calling is enabled on the customer equipment or that the customer equipment is capable of using a specific communication band provided by the wireless telecommunication network. In other examples, the equipment information for the customer equipment 126 may indicate that Wi-Fi calling is disabled on the customer equipment, a developer mode is active on the customer equipment, a location tracking service is active on the customer equipment, and/or so forth.

In various embodiments, prior to acquiring various data mentioned herein (e.g., usage data, device-related information, etc.), the customer usage data collection 108 of the influencer identification application 212 can cause a user interface to display a dialogue box. The dialogue box may ask the user of the in-network customer equipment 126 or an off-network customer equipment 124 for permission to obtain the data. In turn, the user may provide permission by selecting a confirmation option or decline permission by selecting a dismiss option of the dialogue box. In this way, the user is given an opportunity to opt out of the data acquisition. In another example, the influencer identification application 212 can also comprise a privacy module (not pictured) to provide a user interface that enables a user to select or unselect the type of data that may be collected by the customer usage data collection 108. With the use of such a privacy module, the user of the in-network customer equipment 126 or an off-network customer equipment 124 may safeguard his or her privacy.

In certain circumstances, regardless of whether a user has consented to the collection of a specific type of user behavior data, the customer usage data collection 108 can be configured to only collect the specific type of user-related data or other types of data when it is legal to do so in the corresponding legal jurisdiction. In this regard, the customer usage data collection 108 can use a database of privacy rules and regulations to determine the types of user-related data or other types of data that it is permitted to collect under the applicable privacy rules and regulations. Accordingly, the customer usage data collection 108 can refrain from or suspend the collection of one or more specific types of data when the collection is prohibited by the privacy rules and regulations.

The data record or data records can also be stored in a customer database 114 to provide data and processing redundancy, in which data processing and data storage may be scaled in response to demand. The customer database 114 also comprises customer data related to in-network customers. Without limitation, customer data may comprise an in-network customer's wireless service account information, customer's service plan and any usage parameters for the service plan, customer's equipment information, credit information on customers, and/or so forth. The customer account information for an in-network customer may also include account details of multiple users, such as account type, service plan subscription, data consumed, minutes of talk time used, and/or so forth. Additionally, customer data further comprises identifiers correlating with an account that is associated with a plurality of customers' equipment and a plurality of customers (e.g., a user identification associated with a wireless service provider, a wireless carrier, a cellular company, a mobile network carrier, communications service provider, etc.).

In various embodiments, customer data further comprises a customer's social media profile information 138 from each social network in which the customer is a member. For purposes of the present disclosure, the terms “social network” and “social network service” are used in a broad sense and are meant to encompass services aimed at connecting friends and family (often referred to simply as “social networks”), as well as services that are specifically directed to enabling business people to connect and share business information (also commonly referred to as “social networks” but sometimes referred to as “business networks” or “professional networks”).

In various embodiments, the social media profile information 138 can include information confirming an in-network customer's usage of social media. For example, the social media profile information 138 can include the usage volume or social media traffic data, which can reflect the number of connection an in-network customer has via social media. In other embodiments, the social media profile information 138 can include the customer's social links or connections that indicate the customer's connection to other in-network customers and/or off-network customers having a membership on the social network. This digital representation of relationships between an in-network customer and other in-network customers and/or off-network customers is referred to as a social graph. It is contemplated that any two members of a social network may indicate their mutual willingness to be connected in the context of the social network in that they can view each other's profiles, send and/or receive messages to each other, and otherwise be in touch via the social network. The customer's social media profile information can also include or be associated with comments, endorsements, or links from other in-network customers and/or off-network customers in the social network. In various embodiments, a customer's social media profile information can further comprise information such as the recency of a customer connection, professional and affiliation overlap, geographical distance, demographic similarities, and/or so forth.

As customers interact with the various applications, services, and content made available via a social network service, the customer's behavior (e.g., pages visited, etc.) may be monitored and information concerning the customer's behavior may be stored as social media activity 122, for example, in the data store 134. One type of behavior data that may be stored in the customer database 114 is customer activity between a customer having one social media profile with another customer having another social media profile. Other examples of social media activities 122 can include activities where one customer: visits a profile page of another person, contacts another person, saves a member in a contact list, introduces a person to another person (i.e., having a profile in the social network).

The calculation module 102 can be a computer-implemented module that takes certain information (e.g., voice-text activity 116, voice activity 118, SMS activity 120, social media activities 122, etc.) as input, processes it by applying rules and/or machine learning techniques and generates an output that can be utilized by other computer-implemented modules or stored in a repository for future access. The calculation module 102 can calculate customized weights which are used as attributes for PageRank calculations. Additionally, the calculation module 102 can determine various influence scores, including a social media influence score, a voice call influence score, and an SMS influence score associated with an in-network customer. Additionally, the calculation module 102 can determine an acquisition score associated with an off-network customer, wherein the acquisition score is used to determine the likelihood of off-network customers of joining the telecommunication network.

Social media influence score can be computed based on information obtained from the social media profile information 138 (e.g., social media traffic associated with an in-network customer in a social network). In various embodiments, the data associated with an in-network customer on social media may be examined and processed to generate a value that may be viewed as indicative of a social network activity of an in-network customer and thus an influence potential of the associated in-network customer. Such a value may be referred to as a social media influence score and may be made available to the other modules of the influencer identification application. The score can be used to infer how much influence an in-network customer has over other in-network customers and/or off-network customers and predict customer behavior.

For instance, if an in-network customer frequently communicates with a specific contact or connection (i.e., another in-network customer and/or an off-network customer) on a social media platform, it is likely that the in-network customer exchanges text messages with the same contact or connection using a wireless network. Thus, a social graph or a similar digital representation of relationships between an in-network customer and other in-network customers and/or off-network customers on social media networks can be approximated by a SMS graph, which is described using an adjacency matrix that represents texts exchanged between an in-network customer and other in-network customers and/or off-network customers. Similarly, if an in-network customer has many connections on a social media platform, it is likely that the in-network customer's total social media traffic is high. Therefore, social media traffic activity (weight_{SM}) is directly proportional to the number of connections on social media.

In one example embodiment, in order to generate the social media influence score for an in-network customer, the calculation module 102 may first define a customized weight_{SM} associated with the in-network customer. Some examples of data that may be used to define weight_{SM} to determine a social media influence score include but are not limited to the following: 1) confirmed social media usage of an in-network customer; 2) connections data derived from the in-network customer's social graph, if any; 3) number of contacts; and/or 4) traffic volume on the in-network customer's social media profile. Additionally, the calculation module 102 determines the social media PageRank value (PR or PageRank_{SM}), which is a result of convergence of the following PageRank algorithm:

PR(t+1)=H*PR(t)

where H is adjacency matrix containing information on who is talking to whom (i.e., an in-network customer with another in-network customer or an off-network customer) with equally weighted connections. In an example embodiment, an in-network customer's social media influence score is a product of PageRank value (PageRank_{SM}) and social media weight (weight_{SM}). In this way, an in-network customer's social media influence score is directly proportional to his or her social media traffic volume. One of ordinary skill in the art will appreciate, however, that a social media PageRank value may be calculated in any number of appropriate ways.

In one example embodiment, in order to generate the voice call influence score for an in-network customer, the calculation module 102 may first define a customized voice call weight for the in-network customer. Example embodiments may use a variety of information to determine a voice call influence score. Some examples of data that may be used to determine a voice call influence score include but are not limited to the following: 1) minutes of use for voice calls or call duration or call length; 2) call count or call volume; 3) percentage of outbound and inbound calls; 4) number of calls in a given direction; 5) calls to non-contact and/or contact numbers; 6) number of contacts; 7) total volume of calls to each contact; 8) phone numbers accumulated from an in-network customer's address book; and/or 9) call logs.

Additionally, the calculation module 102 determines the voice call PageRank value (PageRank_{V}), using a PageRank algorithm In an example embodiment, an in-network customer's voice call influence score is modified PageRank algorithm, such that voice call weights are passed to the adjacency matrix as attributes. Thus, voice call weights can change the dynamics of PageRank calculation by penalizing short duration and frequency calls. One of ordinary skill in the art will appreciate that a voice call influence score may be calculated in any number of appropriate ways.

In one example embodiment, in order to generate the SMS influence score for an in-network customer, the calculation module 102 may first define a customized SMS weight for the in-network customer. Example embodiments may use a variety of information to determine an SMS influence score. Some examples of data that may be used to determine an SMS influence score include the following: 1) SMS count; 2) SMS size; 3) SMS percentage; 4) number of contacts; 5) phone numbers accumulated from an in-network customer's address book; and/or 6) the total volume of texts to each contact. Additionally, the calculation module 102 determines the SMS PageRank value (PageRank_{SMS}), using the PageRank algorithm In an example embodiment, an in-network customer's SMS influence score is modified PageRank algorithm, such that SMS weights are passed to the adjacency matrix as attributes. Thus, SMS call weights can change the dynamics of PageRank calculation by penalizing short messages and not frequent messages. One of ordinary skill in the art will appreciate that a SMS influence score may be calculated in any number of appropriate ways.

In one example embodiment, in order to generate the acquisition score for an off-network customer, the calculation module 102 may first identify active off-network customers from an in-network customer's phone book 128. The phone book 128 can be approximated and obtained from additional analysis of raw voice and SMS records stored in a data store 134 or a database. As part of such analysis, off-network customers that communicate with in-network customers can be identified using the approximated address book 128. Additionally, the calculation module 102 defines a customized weight as the sum of voice call and SMS activity with in-network customers. Total voice call and SMS weight for each off-network customer is calculated as normalized total volume and the total count of all calls to in-network customers and normalized total SMS size and total SMS count to in-network customers.

Example embodiments may use a variety of information to determine an acquisition score. Some examples of data that may be used to determine an acquisition score include the following: 1) SMS count; 2) SMS size; 3) SMS percentage; 4) texts or calls to numbers; 5) number of contacts; 6) phone numbers accumulated from an in-network customer's address book; 7) the total volume of texts or calls to each contact; 8) minutes of use for voice calls or call duration or call length; 9) call count or call volume; 10) percentage of outbound and inbound calls or texts; 11) number of calls or texts in a given direction; and/or 12) call logs. Additionally, the calculation module 102 determines voice call PageRank and SMS PageRank values (PageRank_{V} and PageRank_{SMS}, respectively) for the off-network customer, using the PageRank algorithm In an example embodiment, an off-network customer's voice call acquisition score is a product of PageRank value (PageRank_{V}) and SMS weight (weighty). Similarly, an off-network customer's SMS acquisition score is a product of PageRank value (PageRank_{SMS}) and SMS weight (weight_{SMS}). One of ordinary skill in the art will appreciate that an acquisition score for an off-network customer may be calculated in any number of appropriate ways.

In addition to the calculation module 102 being configured to generate or compute influence scores of an individual in-network customer, the calculation module 102 can be configured to generate usage statistics of an individual in-network customer of the wireless network, wherein the statistics of in-network individual customers may be provided over a specified time period. The aggregated and/or statistical data determined from an in-network customer's usage data may be compared to the aggregated customer usage information of the subset or all in-network customers of a telecommunication network. The influence scores and the usage statistics can be stored in the data store 134, customer database 114, and/or other databases and made accessible to other modules of the influencer identification application.

The score analysis module 104 may be a computer-implemented module configured to associate influence scores with a specific customer to identify most influential customers. The score analysis module 104 can compare the social media influence score, voice call influence score, and SMS influence score of an individual in-network customer with the social media influence score, voice call influence score, and SMS influence score of an aggregated set of other in-network customers of the telecommunication network in order to determine whether the individual in-network customer has influence scores that are higher as compared to an aggregate of in-network customers. In this regard, a particular in-network customer may be assigned or have calculated for him or her a social media influence score, a voice call score, and an SMS score; and a particular off-network customer may be assigned or have calculated for him or her an acquisition score for voice call and/or SMS.

Similarly, the score analysis module 104 can compare the acquisition score of an individual off-network customer with the acquisition score of an aggregated set of other off-network customers in order to determine whether the individual off-network customer has influence scores that are higher as compared to an aggregate of off-network customers. In this regard, a particular off-network customer may be assigned or have calculated for him or her an acquisition score based on the volume and amount of calls and/or texts the off-network customer has made to and/or received from in-network customers.

Additionally, the score analysis module 104 can analyze usage statistics of an individual in-network customer of the wireless network that are generated by the calculation module 102, wherein the usage statistics can comprise data derived from CDRs 110 and EDRs 112. In one embodiment, analyzing CDRs 110 and EDRs 112 promotes the association of specific customers with their billable usage and specific cell sites where the usage of the specific customers is generated. In various embodiments, the CDRs 110 comprise minutes of usage for voice calls at specific cell sites and the number of megabytes (MB) associated with data usage at specific cell sites for each in-network customer. EDRs 112 comprise duration and data volume associated with data usage at specific cell sites and quality of service per flor or per event at specific cell sites for each in-network customer. From the CDRs 110 and EDRs 112, the set of cell sites most used by the most influential customers may be determined and analyzed. In various embodiments the score analysis module 104 may be configured to provide a report showing influential scores and/or usage statistics. The report may include a chart that lists user identification, the user's influence scores, the user's usage data, and/or so forth.

With some embodiments, the influencer identification application can include a logic layer that generates recommendations for customers. The recommendation module 106 may be a computer-implemented module configured to process data from the calculation module 102 to generate product and/or service recommendations to the most influential customers based on the customers' influence scores. Additionally, the recommendation module 106 can be configured to use the influence scores with or without other information to target marketing to certain influential customers.

### Example Computing Device Components

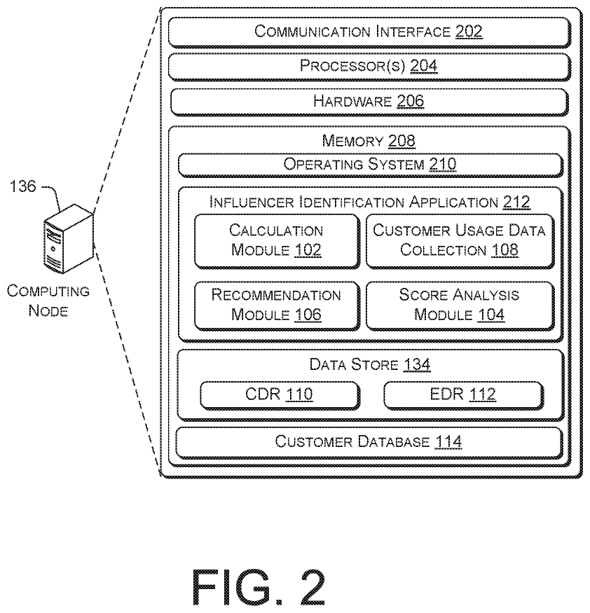

FIG. 2 is a block diagram showing various components of one or more illustrative computing devices that implement customer scoring as described herein. The computing node 136 may include a communication interface 202, one or more processors 204, hardware 206, and a memory unit 208. The communication interface 202 may include wireless and/or wired communication components that enable the devices to transmit data to and receive data from other networked devices. The hardware 206 may include additional hardware interface, data communication, or data storage hardware. For example, the hardware interfaces may include a data output device (e.g., visual display, audio speakers), and one or more data input devices. The data input devices may include but are not limited to, combinations of one or more of keypads, keyboards, mouse devices, touch screens that accept gestures, microphones, voice or speech recognition devices, and any other suitable devices.

The memory unit 208 may be implemented using computer-readable media, such as computer storage media. Computer-readable media includes, at least, two types of computer-readable media, namely computer storage media and communications media. Computer storage media includes volatile and non-volatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or another transmission mechanism.

The processors 204 and the memory unit 208 of the computing node 136 may implement an operating system 210. In turn, the operating system 210 may provide an execution environment for the influencer identification application 212, customer database 114, and/or data store 134. The operating system 210 may include components that enable the computing node 136 to receive and transmit data via various interfaces (e.g., user controls, communication interface, and/or memory input/output devices), as well as process data using the processors 204 to generate output. The operating system 210 may include a presentation component that presents the output (e.g., display the data on an electronic display, store the data in memory, transmit the data to another electronic device, etc.). Additionally, the operating system 210 may include other components that perform various additional functions generally associated with an operating system.

The influencer identification application 212 can include a user interface that can display a graphical depiction of the influence score distribution that can be used for selecting high influencers for targeting purpose or analytics. Additionally, each individual module for the influencer identification application 212 can comprise a user interface.

The customer usage data collection 108 receives and manages customer usage data from in-network customer equipment and off-network customer equipment. The customer usage data collection 108 can store in the data store 134 a data record or multiple data records such as CDRs 110, EDRs 112, and/or IPDRs associated with each customer. In various embodiments, the customer usage data collection 108 can include a cloud layer that controls hardware resources and a data management layer that manages data processing and storage. The cloud layer may provide software utilities for managing computing and storage resources. In various embodiments, the cloud layer may provide a generic user interface for handling multiple underlying storage services that store the data collected by the customer usage data collection 108. The cloud layer may also provide an integrated view of multiple servers and clusters from various providers. Additionally, the cloud layer may provide monitoring utilities to oversee utilization of resources and alerts for managing data storage or processing capacity. Accordingly, the cloud layer may facilitate the deployment, configuration, and activation of local and cloud servers, as well as facilitate the deployment, configuration, and activation of applications and/or services.

The calculation module 102 is configured to calculate a social media influence score, a voice call influence score, an SMS influence score, and an acquisition score. In this regard, the calculation module 102 implements the PageRank algorithm in order to determine the scores, wherein the scores can be assigned to an in-network and/or off-network customer. More specifically, the calculation module 102 determines an influence score by determining the customized weight for a metric category or metric (e.g., social media weight, voice call weight, SMS weight, etc.) and using the customized weight as an attribute to output a page rank value of the metric category or metric.

The score analysis module 104 can compare the social media influence score, voice call influence score, and SMS influence score of an individual in-network customer with the social media influence score, voice call influence score, and SMS influence score of an aggregated set of other in-network customers of the telecommunication network in order to determine whether the individual in-network customer has influence scores that are higher as compared to an aggregate of in-network customers. Similarly, the score analysis module 104 can compare the acquisition score of an individual off-network customer with the acquisition score of an aggregated set of other off-network customers in order to determine the likelihood of the off-network customer to become an in-network customer for the telecommunication network.

The recommendation module 106 is configured to automatically generate product and/or service recommendations to the most influential customers based on the customers' influence scores. Additionally, the recommendation module 106 can be configured to use the influence scores with or without other information (e.g., usage statistics) to target marketing to certain influential customers. In various embodiments, the recommendation module 106 can provide recommendations contemporaneously with receiving the influence scores of an in-network of an off-network customer. In various embodiments, the recommendation module 106 can generate a recommendation log for each customer by storing a plurality of recommendations and rank recommendations based on a context that led to the creation of the one or more recommendations for a customer, wherein the context information can be transmitted or originated from a source such as a telecommunication network, a third party, or an in-network customer.

The memory unit 208 may also include a data store 134 and a customer database 114. In various embodiments, the data store 134 includes one or more databases. For example, these data stores may include Hadoop Distributed File System™ (HDFS), Apache Spark™, Apache HBase™, and/or so forth. The data store 134 can work in conjunction with the customer usage data collection 108 such that the data may be distributed and stored in different data stores. Further, the data store 134 can comprise data adaptors for obtaining multiple types of data, including CDRs 110 and EDRs 112.

In various embodiments, the data store 134 can comprise a customer database 114. The customer database 114 comprises customer-related information such as customer account information, which includes service plan information and any usage parameters for the service plan. The customer account information can include account details of a customer and multiple users associated with the customer, including account type, billing preferences, service plan subscription, payment history, data consumed, minutes of talk time used, and/or so forth.

### Example Processes

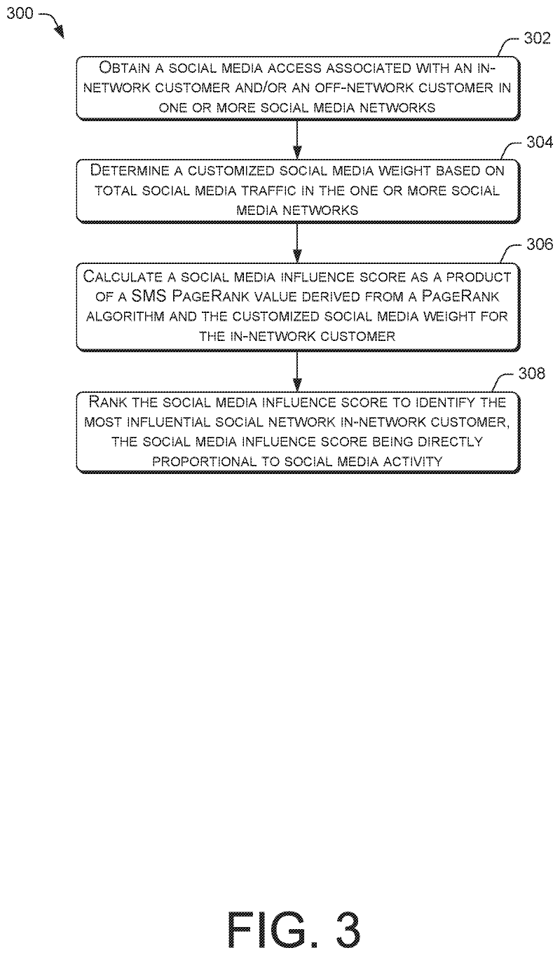

FIGS. 3-6 present illustrative processes 300-600 for using the present influencer identification application to determine a social media influence score, voice call influence score, SMS influence score, and acquisition score. Each of the processes 300-600 is illustrated as a collection of blocks in a logical flow chart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes 300-600 are described with reference to the architecture 100 of FIG. 1.

FIG. 3 is a flow diagram of an example process 300 for determining a social media influence score. At block 302, the customer usage data collection obtains a social media access in one or more social media networks for an in-network customer in order to identify the customer's connections that overlap with contacts in the customer's address book. In this regard, if a person is connected with the customer on a social media platform and the person is one of the customer's contacts in the customer's address book, it is assumed that in addition to communicating on the social media platform, the customer also communicates with the person via SMS and/or voice call within a specific time period.

At block 304, the calculation module determines social media weight based on total social media traffic in the one or more social media networks. More specifically, the total social media traffic information can include total usage volume for each specific social media network, the total number of hits for each social media network, and the total volume from the aggregate social media networks. It is contemplated that in various embodiments, other related information derived from EDRs can be used. At block 306, the calculation module calculates a social media influence score as a product of SMS PageRank value derived from the PageRank algorithm, where all connections are treated equally with no consideration of SMS frequency and data size, and the calculated social media weight that is custom to each in-network customer.

At block 308, the score analysis module analyzes each social media influence score to rank the social media influence score, thereby identifying an in-network customer with the highest social media influence score, which signifies the most social media activity. In various embodiments, the score analysis module can log the calculated social media influence scores in the data store and/or the customer database, wherein each score can be associated with a specific customer to generate recommendations via the recommendation module.

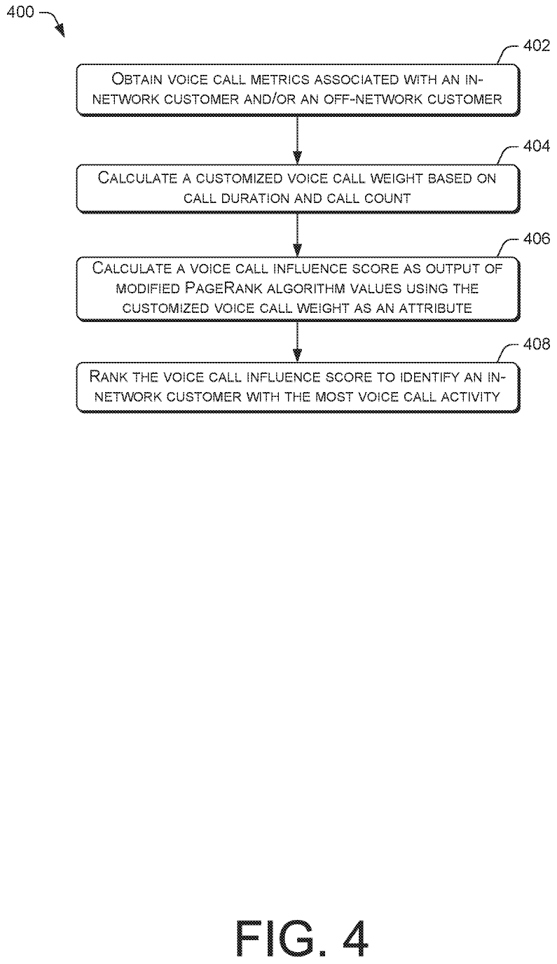

FIG. 4 is a flow diagram of an example process 400 for determining a voice call influence score. At block 402, the customer usage data collection obtains voice call metrics such as direction of call, duration, and frequency of calls associated with an in-network customer and/or an off-network customer. At block 404, the calculation module calculates a customized voice call weight for all users registered in network which can include in-network and out-of-network customers. In various embodiments, the voice call weight can be based at least partially on call duration and call count between customers. It is contemplated that in various embodiments, other related information derived from CDRs can be used.

At block 406, the calculation module calculates a voice call influence score as output of modified PageRank algorithm values such that the customized voice call weight for each customer registered in network is used as attributes for PageRank algorithm At block 408, the score analysis module ranks the voice call influence score to identify an in-network customer with the most voice call activity and most active connections. In various embodiments, the score analysis module can log the calculated voice call influence scores in the data store and/or the customer database, wherein each score can be associated with a specific customer to generate recommendations via the recommendation module.

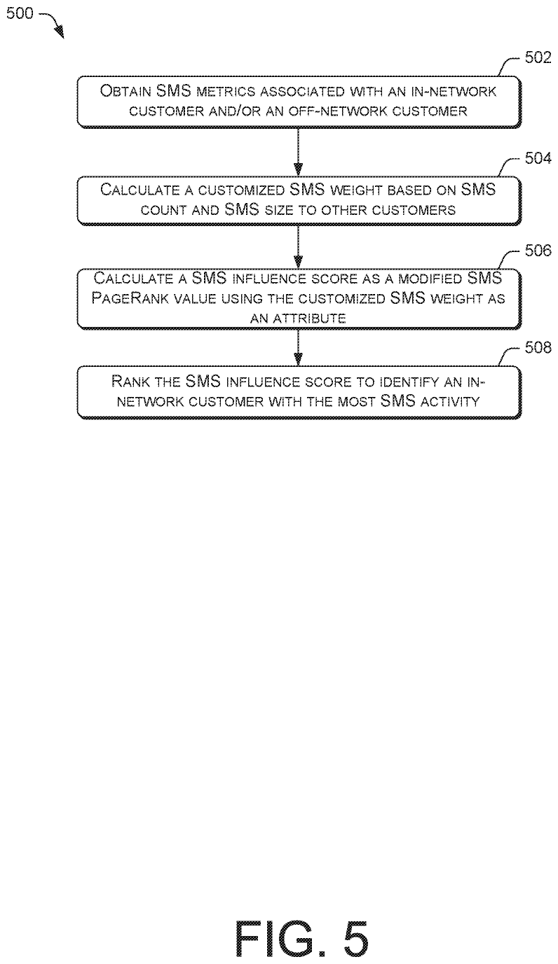

FIG. 5 is a flow diagram of an example process 500 for determining an SMS influence score. At block 502, the customer usage data collection obtains SMS metrics such as SMS package size, frequency, and direction of SMS associated with an in-network and/or an off-network customer. At block 504, the calculating module calculates a customized SMS weight for all customers detected in network based on SMS count and SMS file size to other in-network and off-network customers in the approximated customer's address book. It is contemplated that in various embodiments, other related information derived from CDRs can be used.

At block 506, the calculation module calculates an SMS influence score as a modified SMS PageRank value. It requires the customized SMS weight for each registered customer in network which are used as attributes for PageRank algorithm. At block 508, the score analysis module ranks the SMS influence score to identify an in-network customer with the most SMS activity. In various embodiments, the score analysis module can log the calculated SMS influence scores in the data store and/or the customer database, wherein each score can be associated with a specific customer to generate recommendations via the recommendation module.

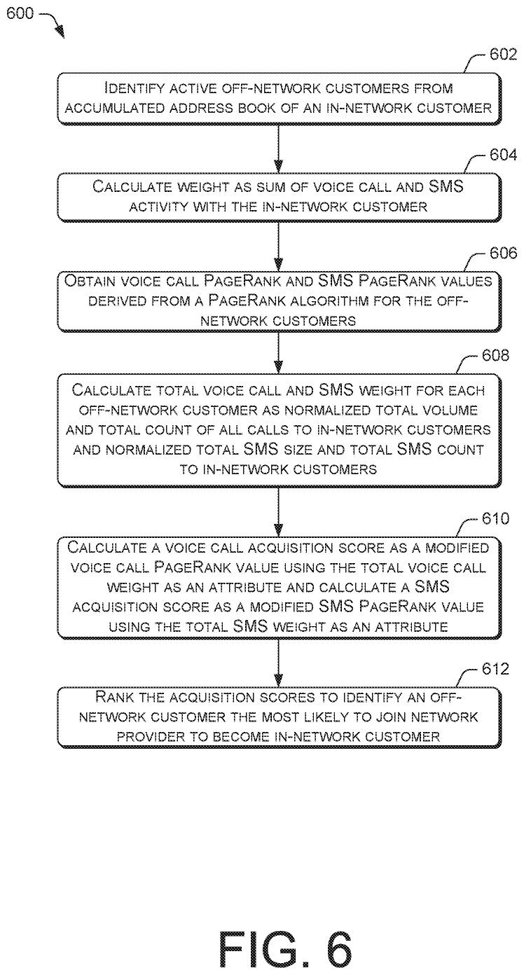

FIG. 6 is a flow diagram of an example process 600 for determining an acquisition score for off-network customers. At block 602, the customer usage data collection identifies active off-network customers from an accumulated address book of an in-network customer. At block 604, the calculation module calculates a customized weight for an off-network customer as the sum of voice call and SMS activity with one or more in-network customers. At block 606, the calculation module collects voice call PageRank and SMS PageRank values derived from the PageRank algorithm for off-network customers. At block 608, the calculation module calculates total voice call weight and total SMS weight for each off-network customer as normalized total volume and the total count of all calls to in-network customers and normalized total SMS size and total SMS count to in-network customers, respectively. At block 610, the calculation module calculates a voice acquisition score as a modified voice call PageRank value using the total voice call weight as an attribute for each off-network customer. The calculation module also calculates an SMS acquisition score as a modified SMS PageRank value using the total SMS weight as an attribute for each off-network customer. At block 612, the score analysis module ranks the voice acquisition score and the SMS acquisition score to identify an off-network customer that is most likely to join the telecommunication network and become a new in-network customer.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. One or more non-transitory computer-readable media storing computer-executable instructions that upon execution cause one or more processors to perform acts comprising:
obtaining a social graph associated with a customer in one or more social media networks, the social graph comprising social connections to the customer;
determining social media weight based on total social media traffic associated with the in-network customer in the one or more social media networks; and
calculating a social media influence score associated with the customer as a product of a social media PageRank value and the social media weight, the social media influence score being based on the customer's activities on the one or more social media networks.

2. The one or more non-transitory computer-readable media of claim 1, wherein at least one of the social connections overlaps with contacts stored in the customer's address book.

3. The one or more non-transitory computer-readable media of claim 1, wherein the social media weight and the social media PageRank value utilizes an identifier correlating with an account that is associated with a plurality of customer equipment and a plurality of customers.

4. The one or more non-transitory computer-readable media of claim 1, wherein the acts further comprise:
comparing the social media influence score associated with the customer to social media influence scores of an aggregated set of other customers; and
if the social media influence score associated with the customer is greater than the social media influence scores of the aggregated set of other customers, identifying the customer as the most influential social media customer.

5. The one or more non-transitory computer-readable media of claim 1, wherein the acts further comprise:
generating a recommendation at least partially based on the social media influence score upon receiving context information from a source.

6. The one or more non-transitory computer-readable media of claim 1, wherein the total social media traffic comprises total usage volume for each of the one or more social media networks, a total number of hits for each of the one or more social media networks, and the total volume from aggregate social media networks.

7. A computer-implemented method, comprising:
obtaining a PageRank value associated with a customer;
calculating a customized weight associated with the customer at least partially based on data derived from call detail records (CDRs); and
calculating an influence score associated with the customer as an output of a modified PageRank value using the customized weight as an attribute, the influence score being based on the customer's activities on a wireless network.

8. The computer-implemented method of claim 7, wherein the PageRank value is calculated by using a PageRank algorithm.

9. The computer-implemented method of claim 7, wherein the PageRank value comprises a voice call PageRank value and the customized weight comprises a voice call weight, the voice call weight at least partially based on call duration and call count to other customers in the customer's address book.

10. The computer-implemented method of claim 7, wherein the PageRank value comprises an SMS PageRank value and the customized weight comprises an SMS weight, the SMS weight at least partially based on SMS count and SMS size to other customers in the customer's address book.

11. The computer-implemented method of claim 7, wherein the customized weight and the PageRank value utilizes an identifier correlating with an account that is associated with a plurality of customer equipment and a plurality of customers.

12. The computer-implemented method of claim 7, further comprising the steps of:
comparing the influence score associated with the customer to influence scores of an aggregated set of other customers; and
if the influence score associated with the customer is greater than the influence scores of the aggregated set of other customers, identifying the customer as the most influential customer.

13. The computer-implemented method of claim 7, further comprising the steps of:
generating a recommendation at least partially based on the influence score upon receiving context information from a source.

14. The computer-implemented method of claim 7, wherein the customized weight associated with the customer at least partially based on data derived from enhanced data records (EDRs).

15. The computer-implemented method of claim 7, wherein the CDRs comprise voice text activity, voice call activity, and SMS activity.

16. A system, comprising:
one or more processors; and
a memory including a plurality of computer-executable components that are executable by the one or more processors to perform a plurality of actions, the plurality of actions comprising:
identifying an off-network customer that actively communicates with an in-network customer, the in-network customer having an address book comprising contact information associated with the off-network customer;
obtaining a voice call PageRank value and SMS PageRank value associated with the off-network customer;
calculating a customized weight associated with the off-network customer, wherein the customized weight is a sum of the off-network customer's voice call and SMS activity with the in-network customer; and
calculating a total voice call weight associated with the off-network customer at least partially based on a normalized total volume and a total count of all calls to the in-network customer and a total SMS weight associated with the off-network customer at least partially based on a normalized total SMS size and total SMS count to the in-network customer.

17. The system of claim 16, further comprising:
calculating a voice call acquisition score as a modified voice call PageRank value using the total voice call weight as an attribute.

18. The system of claim 16, further comprising:
calculating an SMS acquisition score as a modified SMS PageRank value using the total SMS weight as an attribute.

19. The system of claim 17, further comprising:
comparing the voice call acquisition score associated with the off-network customer to voice call acquisition scores of an aggregated set of other off-network customers; and
if the voice call acquisition score associated with the off-network customer is greater than the voice call acquisition scores of the aggregated set of other off-network customers, identifying the off-network customer as the most likely to become a new in-network customer.

20. The system of claim 18, further comprising:
comparing the SMS acquisition score associated with the off-network customer to SMS acquisition scores of an aggregated set of other off-network customers; and
if the SMS acquisition score associated with the off-network customer is greater than the SMS acquisition scores of the aggregated set of other off-network customers, identifying the off-network customer as the most likely to become a new in-network customer.
